(19) United States
(12) Patent Application Publication
(10) Pub. No.: US 2010/0314881 A1
(43) Pub. Date: Dec. 16, 2010

(54) Auxiliary drive/brake system for a wind turbine

(75) Inventor: Richard Stone, Teaneck, NJ (US)

Correspondence Address: Hertan, Burstein, Sheridan Cevasco, Bottinelli,;Litt & Harz, L . L . C., 21 Main Street, Suite 353, Court Plaza South, 3rd Floor, Hackensack, NJ, 07601, US

(73) Assignee: CHALLENGER DESIGN LLC

(21) Appl. No.: 12/457,531

(22) Filed: Jun. 15, 2009

(51) Int. Cl. F03D 9/00; H02P 27/00; H02K 7/116

(52) U.S. Cl. 290/55; 318/400.3; 310/83

(57) ABSTRACT

An auxiliary drive/brake system for a wind turbine. The auxiliary drive/brake system includes an impulse, high torque electric motor connected to a motor drive control system which controls the impulse high torque electric motor. The auxiliary drive/brake system further includes a gearbox transmission, a drive shaft, and a transfer gearbox that connects to either the wind turbine low-speed shaft or to the wind turbine gearbox. The drive system provides impulse operation of the wind turbine. Control of the auxiliary drive/brake system is performed by an electronic speed control in combination with either a motor drive control system or an electronic variable speed drive. Torque and horsepower created by the present auxiliary drive/brake system is transferred into the wind turbine low-speed shaft where it combines with the torque and horsepower created by the wind acting on the wind turbine rotor blades, the combined torque and horsepower is transferred from the wind turbine low-speed shaft into the wind turbine gearbox and the wind turbine generator, causing the wind turbine generator to operate and produce electricity which is supplied to the power company.

### BACKGROUND OF THE INVENTION

1. Field of the Invention

The present invention relates to wind turbines. More particularly, the invention relates to an auxiliary drive/brake system for use in conjunction with a wind turbine.

2. Description of the Related Art

A wind turbine is not generally a reliable method for electricity generation because it depends entirely on the presence and strength of the wind in order to operate. Wind turbines cannot generate electricity when the wind speed is too low, the wind is intermittent, the wind stops suddenly, or the wind speed is too high. The variable and random nature of the wind makes it difficult for power companies to use wind turbines for reliable electricity generation because changes to the wind create an immediate change in the amount of electricity available for transmission.

The greatest problem is when the wind stops or drops suddenly and forces multiple wind turbines to stop producing electricity. The resulting rapid and immediate drop in electricity output causes a large shortage of electricity that power companies must replace quickly in order to avoid creating a blackout or a brownout of its customers as well as overload damage of its electricity transmission system.

As those skilled in the art will certainly appreciate, and with reference to FIG. 1 the basic wind turbine is composed of wind turbine rotor blades 7 connected to the wind turbine low-speed shaft 8. The wind turbine low-speed shaft 8 drives the wind turbine gearbox 9 by means of the input shaft 10 of the wind turbine gearbox 9. The output shaft 11 of the wind turbine gearbox 9 drives the wind turbine high-speed shaft 12. The wind turbine high-speed shaft 12 connects to the input shaft 13 of the wind turbine generator 14. The wind turbine generator 14 produces the electricity that is supplied to the electricity transmission network of the power company. The wind turbine rotor blades 7 are powered by wind only. This restricts the wind turbine generator 14 because the wind turbine generator 14 can only produce electricity when wind is available to turn the wind turbine rotor blades 7 at the required rpm (shaft speed).

The yaw control mechanism rotor blades 31 are used to position the wind turbine rotor blades 7 to further engage or disengage the wind, and the input shaft brake mechanism 33, provided the wind turbine is equipped with it, is used to slow the wind turbine low-speed shaft 8 and the wind turbine rotor blades 7 if these rotate above the maximum allowable rpm (shaft speed). The wind turbine gearbox 9 and the wind turbine generator 14 are installed on the base plate 20. The base plate 20 is attached to the wind turbine tower 22 by the rotating joint 21. The rotating joint 21 allows the wind turbine to rotate in the horizontal plane (yaw) about the wind turbine tower 22 whenever the wind changes direction. The wind turbine nacelle 37 covers and protects the internal components of the wind turbine.

As discussed above, current wind turbines are not generally reliable for use in electricity generation because they depend entirely on the presence and strength of the wind in order to operate. As result, a need exists for a mechanism by which wind turbines may be used in a variety of wind conditions so as to make them commercially feasible for implementation by power companies.

### SUMMARY OF THE INVENTION

It is, therefore, an object of the present invention to provide an auxiliary drive/brake system for a wind turbine. The wind turbine includes wind turbine rotor blades connected to a wind turbine low-speed shaft. The wind turbine low-speed shaft drives a wind turbine gearbox via an input shaft of the wind turbine gearbox, an output shaft of the wind turbine gearbox and a wind turbine high speed shaft which connects to an input shaft of the wind turbine generator that produces electricity that is supplied to a power company electricity transmission network. The auxiliary drive/brake system includes an impulse, high torque electric motor connected to a motor drive control system which controls the high torque electric motor. The auxiliary drive/brake system further includes a gearbox transmission, a drive shaft, and a transfer gearbox that connects to either the wind turbine low-speed shaft or to the wind turbine gearbox. Control of the auxiliary drive/brake system is performed by an electronic speed control in combination with either a motor drive control system or an electronic variable speed drive. Torque and horsepower created by the present auxiliary drive/brake system is transferred into the wind turbine low-speed shaft where it combines with the torque and horsepower created by the wind acting on the wind turbine rotor blades. The combined torque and horsepower is transferred from the wind turbine low-speed shaft into the wind turbine gearbox and the wind turbine generator, causing the wind turbine generator to operate and produce electricity which is supplied to the power company.

It is a further object of the present invention to provide an auxiliary drive/brake system wherein the high torque electric motor includes a lightweight high strength frame supporting a large motor shaft and an external air blower.

It is also an object of the present invention to provide an auxiliary drive/brake system wherein the high torque electric motor is powered by AC electric power delivered from an AC power line, DC electric power converted from AC or DC electric power supplied by a storage battery.

It is another object of the present invention to provide an auxiliary drive/brake system wherein gearbox transmission is a gearbox using fixed ratio gearing.

It is a further object of the present invention to provide an auxiliary drive/brake system wherein the transfer gearbox is connected to the wind turbine low-speed shaft by a first drive coupling and an opposite side of the transfer gearbox is attached to the input shaft of the wind turbine gearbox by a second drive coupling.

It is another object of the present invention to provide an auxiliary drive/brake system wherein the transfer gearbox is built directly into the gearbox transmission.

It is also an object of the present invention to provide an auxiliary drive/brake system wherein the transfer gearbox is built directly into the wind turbine gearbox.

It is a further object of the present invention to provide an auxiliary drive/brake system wherein the motor drive control system controls the high torque electric motor.

It is another object of the present invention to provide an auxiliary drive/brake system wherein the motor drive control system includes means for controlling the operation speed and direction of rotation of the high torque electric motor, adjusting the speed of the high torque electric motor to suit the operating conditions of the wind turbine, enabling the high torque electric motor to be started and stopped with reduced shock load, and enabling the high torque electric motor to be used as a generator for dynamic braking of the wind turbine.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of a conventional wind turbine as known in the prior art.

FIGS. 2, 3 and 4 are schematics of a wind turbine employing the present auxiliary drive/brake system in accordance with various embodiments of the present invention.

FIGS. 5 and 6 are respectively a longitudinal cross sectional view and a lateral cross sectional view of the high torque motor employed in accordance with a preferred embodiment of the present invention.

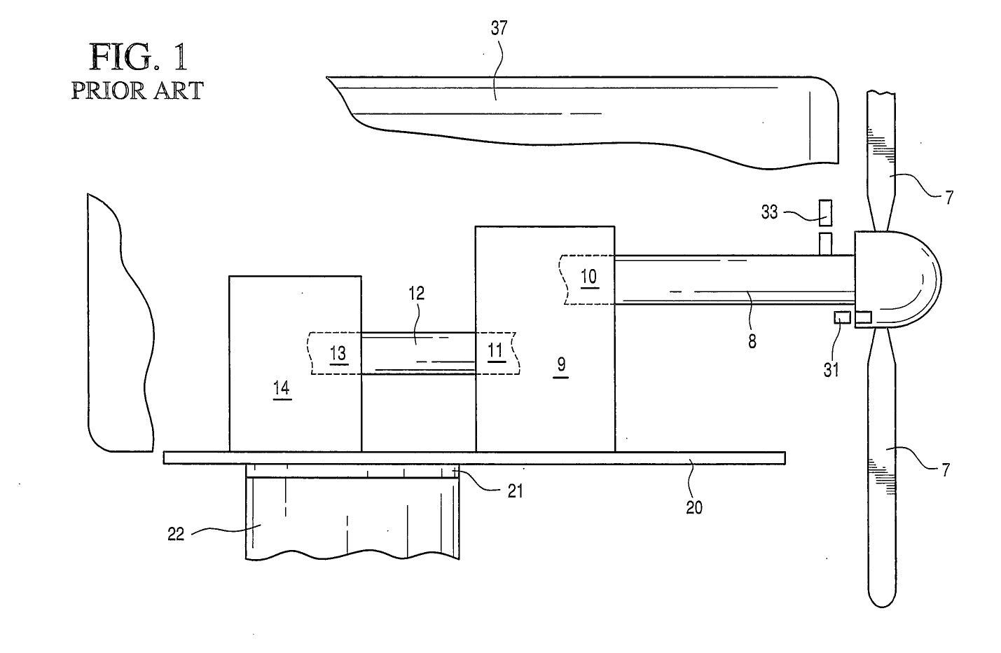

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

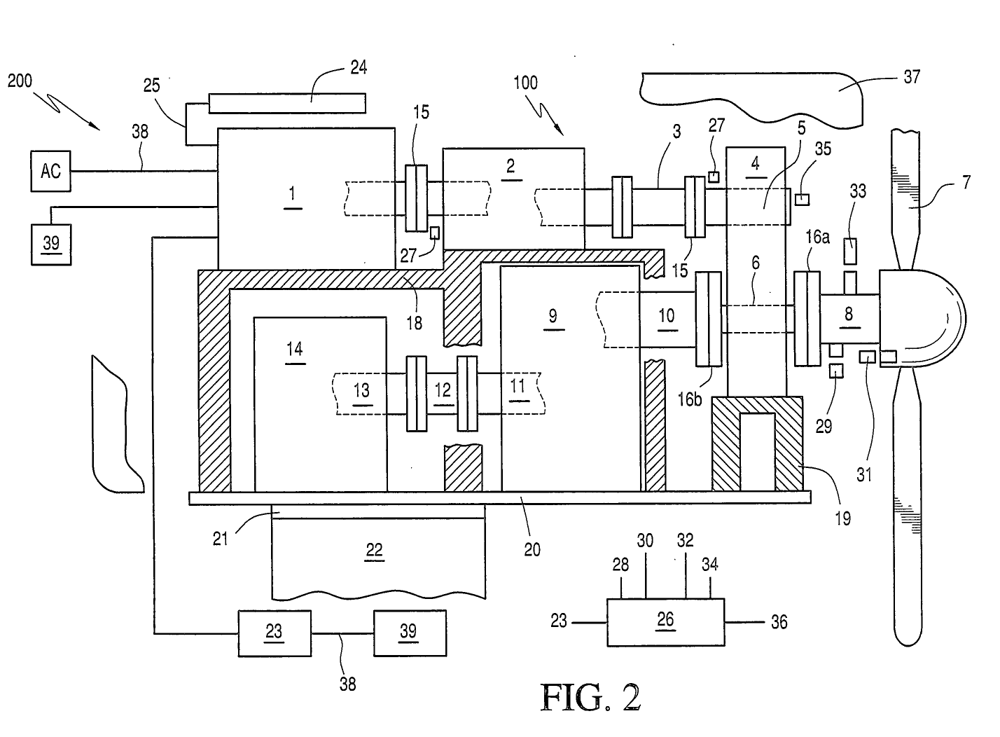

In accordance with the present invention, and with reference to the various embodiments disclosed in FIGS. 2, 3, and 4, an auxiliary drive/brake system 100 for a wind turbine 200 is disclosed. Although the present auxiliary drive/brake system 100 is disclosed in accordance with preferred wind turbine 200 for the purpose of disclosing the invention, it will be appreciated that it is contemplated the present auxiliary drive/brake system 100 may be utilized in conjunction with a variety of wind turbine designs.

The present auxiliary drive/brake system 100 improves a range of operation for the wind turbine 200 by enabling the wind turbine 200 to remain in operation and generate electricity for a longer period of time when the wind stops entirely in order to provide power companies sufficient time to bring a replacement electricity generation resource into operation. When the wind speed is too intermittent to enable normal wind only operation, the present auxiliary drive/brake system 100 enables the wind turbine 200 to remain in operation and generate electricity. When the wind speed is below the minimum wind speed required for normal wind only operation, the present auxiliary drive/brake system 100 enables the wind turbine 200 to remain in operation and generate electricity. When the wind speed exceeds the maximum allowable wind speed, the present auxiliary drive/brake system 100 enables the wind turbine 200 to remain in operation and generate electricity.

Briefly, and as will be discussed below in greater detail, the present auxiliary drive/brake system 100 includes an high torque electric motor 1, a gearbox/transmission 2, a drive shaft 3 and a transfer gearbox 4. The transfer gearbox 4 connects to either the wind turbine low-speed shaft 8 or to the wind turbine gearbox 9. A motor drive control system 23 controls the high torque electric motor 1. These parts form an independent drive train that connects the present auxiliary drive/brake system 100 to the wind turbine 200 connecting the transfer gearbox 4 to either the wind turbine low-speed shaft 8 or the wind turbine gearbox 9. The control of the auxiliary drive/brake system 100 is performed by an electronic speed control in combination with either a motor drive control system 23 or an electronic variable speed drive.

In practice, it is contemplated there are four possible methods for utilization of the present auxiliary drive/brake system 100. In accordance with a first embodiment, when the wind stops entirely and causes the wind turbine 200 to suddenly stop producing electricity, the auxiliary drive/brake system 100 is operated by the impulse method to enable the wind turbine 200 to keep generating electricity for a longer (but limited) period of time. This longer time period provides a power company enough time to bring a replacement electricity generation resource into operation in an orderly manner to prevent an upset to its electricity transmission line system and “blackout” or “brownout” to its customers. The impulse method consists of operating the high torque electric motor 1 in a repeated “start-stop” manner to provide multiple short duration power “impulses” into the wind turbine rotor blades 7 in order to keep these turning at a high enough speed to enable the wind turbine generator 14 to continue to produce electricity. The value of the torque and horsepower created by each impulse equals a high proportion (in the range of 50% or higher) of the total of the torque and horsepower required to operate the wind turbine generator 200. The torque and horsepower of each impulse is combined with the torque and horsepower that remains in the rotating wind turbine rotor blades 7 to enable the wind turbine generator 200 to continue to produce electricity.

The impulse method of operation is based upon the ability of the high torque electric motor 1 to repeatedly produce motor torque and horsepower that exceeds the value produced by a standard electric motor by approximately four (4) times (400%) each time the motor is started. These high values are produced for a limited time period during each motor start-up. The time period of each powered impulse will range between several seconds to several minutes. It is determined based upon the mass and polar moment of inertia of the wind turbine rotor blades 7, the size and power of the high torque electric motor 1 and the gear ratio and arrangement of the auxiliary drive/brake system 100.

The impulse method of operation functions because the large mass and polar moment of interia of the wind turbine rotor blades 7 causes it to serve in the same manner as a fly wheel and store the energy imparted into it by each impulse operation of the high torque electric motor 1 as momentum. When the high torque electric motor 1 is stopped after each powered impulse, the flywheel momentum effect of the wind turbine rotor blades 7 causes the blades to continue turning the wind turbine generator 14 for a certain period of time as the energy is dissipated. This enables the wind turbine generator 14 to continue producing electricity.

The increase in the shut down time period (when employed in conjunction with the “impulse” methodology) allowing the wind turbine to continue generating electricity after the wind has stopped and the time period during which the impulse method can be used are dependent upon the power of the high torque electric motor 1, the design of the auxiliary drive/brake system 100 parts and the size and design of the wind turbine 200.

The net electric power produced by the wind turbine generator 14 during this shut down period of operation is the difference between its minimum rating and the electricity required to operate the high torque electric motor 1 during each impulse period of operation.

In accordance with a second methodology, when the wind is too intermittent for normal wind only operation, the auxiliary drive/brake system 100 is operated in either of the following two modes: in accordance with a first mode, the methodology is similar to that described above with regard to the first embodiment. The high torque electric motor 1 is operated in a repeated start-stop manner to provide multiple short duration power impulses into the wind turbine rotor blades 7 in order to keep the blades turning at a high enough speed to enable the wind turbine generator 14 to continue to produce electricity. The impulse torque and horsepower are combined with the torque and horsepower created by the wind turbine rotor blades 7 from the available wind to enable the wind turbine generator 14 to continue to produce electricity. This method of operation is continued until the wind speed increases enough for the wind turbine 200 to resume wind only operation or until the lack of wind forces the wind turbine 200 to be removed from service. The net electric power produced by the wind turbine generator 14 is the difference between its minimum output rating and the electric power required to operate the high torque electric motor 1 during each impulse of operation.

In accordance with a second mode, the high torque electric motor 1 is engaged to get the wind turbine rotor blades 7 up to speed and then the high torque electric motor 1 is disengaged. The wind turbine rotor blades 7 slow to a certain rpm, in intermittent wind, at which time, the motor is again engaged.

In accordance with a third methodology, when the wind speed is below the minimum speed needed for wind only operation, but is high enough to enable the wind turbine rotor blades 7 to rotate steadily, the high torque electric motor 1 is operated at its normal steady speed to produce its normal rated torque and horsepower. The torque and horsepower created by the high torque electric motor 1 are added to the torque and horsepower created by the wind turbine rotor blades 7 from the available wind. The combination of the two power sources enables the wind turbine generator 14 to continue to produce electricity. This method of operation is continued until the wind speed increases enough for the wind turbine 200 to resume wind only operation. The net electric power produced by the wind turbine generator 14 is the difference between its minimum output rating and the electric power required to operate the high torque electric motor 1 at a steady-state speed. This method enables the wind turbine 200 to generate electricity at a lower wind speed than one not equipped with the auxiliary drive/brake system 100. The determination of what the lowest wind speed is for this method is dependent on the design of the wind turbine rotor blades 7.

In accordance with a fourth methodology, when the wind speed exceeds the maximum allowable range for wind operation, the auxiliary drive/brake system 100 is operated as a dynamic braking system to enable the wind turbine 200 to remain in operation and continue to generate electricity. The dynamic brake action is obtained by having the electric motor function as a generator that is driven by the wind turbine rotor blades 7. The force required to operate the electric motor as a generator serves as the actual dynamic braking force. The electricity generated by the electric motor when it operates as a generator is converted into heat by directing it into a resistor grid 24 located on the exterior of the wind turbine nacelle 37. This allows the heat to be safely dissipated into the surrounding air.

As the various embodiments above disclose, control of the present auxiliary drive/brake system 100 is important. The auxiliary drive/brake system 100 can be activated either automatically or manually whenever it is necessary for the wind turbine 200 to generate electricity as described above with regard to the four methods of use for the present auxiliary drive/brake system 100. Similarly, the auxiliary drive/brake system 100 can be deactivated either automatically or manually whenever the wind conditions enable the wind turbine 200 to generate electricity by normal wind only operation.

Any motor used in conjunction with the present invention must allow for operation such that the drive motor exceeds the power created by the wind turbine generator 14. As discussed herein in greater detail, this is achieved by the provision of a high torque electric motor 1.

The present auxiliary drive/brake system 100 overcomes these restrictions by limiting the size of the drive motor to produce only a portion of the torque and horsepower required by the wind turbine generator 14 and wind turbine 200 for steady state operation. The remaining power required by the wind turbine generator 14 and wind turbine 200 is supplied by either the wind, when it is present at a low-speed, or by the energy remaining in the rotating wind turbine rotor blades 7.

This design of the present auxiliary drive/brake system 100 also capitalizes on the ability of the special design drive motor (that is, the high torque electric motor 1) to produce higher values of torque for a limited period of time during start-up. This creates impulses of torque that are imparted into the rotating wind turbine rotor blades 7 to keep it turning and enable the wind turbine generator 14 to continue to produce electricity.

As discussed above, great problems are encountered when a power company must replace electricity quickly in order to avoid creating a “blackout” or a “brownout” as well as overload damage of its electricity transmission system. The present method that power companies use to control this problem is to limit the amount of wind turbine generated electricity that it transmits in order to reduce the extent of the loss when it occurs. This self-imposed limitation results in a loss of revenue to the power company and a lower return on investment from its wind turbines.

As discussed above, a traditional wind turbine 200, for example, one which may be used in conjunction with the present auxiliary drive/brake system 100 is composed of wind turbine rotor blades 7 connected to the wind turbine low-speed shaft 8. The wind turbine low-speed shaft 8 drives the wind turbine gearbox 9 by means of the input shaft 10 of the wind turbine gearbox 9. The output shaft 11 of the wind turbine gearbox 9 is connected to and drives the wind turbine high-speed shaft 12. The wind turbine high-speed shaft 12 connects to the input shaft 13 of the wind turbine generator 14. The wind turbine generator 14 produces the electricity that is supplied to the power company electricity transmission network. The wind turbine rotor blades 7 are powered by wind only. This restricts the wind turbine generator 14 because it can only produce electricity when wind is available to turn the wind turbine rotor blades 7 at the required rpm (shaft speed).

The yaw control mechanism 31 is used to position the wind turbine rotor blades 7 to further engage or disengage the wind, the input shaft brake mechanism 33, provided the wind turbine 200 is equipped with it, is used to slow the wind turbine low-speed shaft 8 and the wind turbine rotor blades 7 if these rotate above the maximum allowable rpm (shaft speed). The wind turbine gearbox 9 and the wind turbine generator 14 are installed on the base plate 20. The base plate 20 is attached to the wind turbine tower 22 by the rotating joint 21. The rotating joint 21 allows the wind turbine 200 to rotate in the horizontal plane (yaw) about the wind turbine tower 22 whenever the wind changes direction. The wind turbine nacelle 37 covers and protects the internal components of the wind turbine 200.

The installation of the present auxiliary drive/brake system 100 for use in conjunction with a wind turbine 200 as described above enables the wind turbine 200 to generate a portion of its rated Megawatt output reliably whenever the wind speed is too low or too intermittent to enable normal wind only operation. In the event the wind stops, the auxiliary drive/brake system 100 enables the wind turbine 200 to remain in operation and generate electricity for a limited period of time in order to provide the power company time to bring replacement electricity generation sources into operation.

In addition, the present auxiliary drive/brake system 100 enables the wind turbine 200 to remain in operation and generate its full rated Megawatt output whenever the wind speed exceeds the maximum allowable wind speed by having the high torque electric motor 1 provide dynamic braking of rotating wind turbine rotor blades 7.

More particularly, and with reference to the various embodiments disclosed in FIGS. 2, 3 and 4, the auxiliary drive/brake system (ADBS) 100 includes a high torque electric motor 1, an ADBS gearbox/transmission 2, an ADBS transfer gearbox 4, and an ADBS driveshaft 3. The ADBS transfer gearbox 4 connects to and operates the wind turbine low-speed shaft 8 and the wind turbine gearbox 9. The wind turbine low-speed shaft 8 is the “input shaft” that connects the wind turbine rotor blades 7 to the wind turbine gearbox 9, which connects to and operates the wind turbine generator 14. The auxiliary drive/brake system 100 is arranged to enable it to rotate with the wind turbine nacelle 37 when it rotates (yaws) with the change in wind direction.

When the auxiliary drive/brake system 100 is used to drive the wind turbine 200, the motor drive control system 23 controls and operates the high torque electric motor 1 to drive the ADBS gearbox/transmission 2, the ADBS driveshaft 3, and the ADBS transfer gearbox 4.

The torque and horsepower created by the present auxiliary drive/brake system 100 is transferred into the wind turbine low-speed shaft 8 where it combines with the torque and horsepower created by the wind acting on the wind turbine rotor blades 7. The combined torque and horsepower is transferred from the wind turbine low-speed shaft 8 into the wind turbine gearbox 9 and the wind turbine generator 14. This causes the wind turbine generator 14 to operate and produce electricity in the normal manner. The electricity is supplied to the power company by the existing electricity transmission line network.

When the present auxiliary drive/brake system 100 is not in use, the high torque electric motor 1, the ADBS gearbox/transmission 2, the ADBS driveshaft 3 and the ADBS transfer gearbox 4 are turned freely (“back driven”) by the wind turbine low-speed shaft 8 when the wind turbine rotor blades 7 operates by wind.

When the auxiliary drive/brake system 100 is used to provide dynamic braking for the wind turbine 200, a portion of the torque and horsepower created by the wind turbine rotor blades 7 is transferred from the wind turbine low-speed shaft 8 into the ADBS transfer gearbox 4, the ADBS driveshaft 3, the ADBS gearbox 2, and the high torque electric motor 1. The motor drive control system 23 then reverses the electric field of the high torque electric motor 1 so that it operates as a generator. The electricity created by the high torque electric motor 1 when it is operated as a generator is directed to the resistor grid 24 by the resistor grid power cable 25. The resistor grid 24 converts the electricity into heat and dissipates it into the air on the exterior of wind turbine nacelle 37.

The dynamic braking action is created by the torque and horsepower absorbed from the wind turbine 200 that is required to operate the high torque electric motor 1 as a generator. The dynamic braking action exceeds the braking action that the input shaft brake mechanism 33 can provide.

The dynamic braking action enables the maximum allowable wind speed that the wind turbine 200 is designed to operate with to be increased. This allows the wind turbine to remain in operation and generate electricity instead of being removed from service.

The high torque electric motor 1 can produce approximately four (4) times (400%) the rate of torque of a standard motor, repeatedly, without overheating and/or motor failure. This is an important part of the invention. The standard motor on start up can, for a short time exhibit start up torques 200-300% over normal running torque but is limited to being started only 2-3 times/hr or else it overheats. This is compared with the present motor as described in the previous sentence.

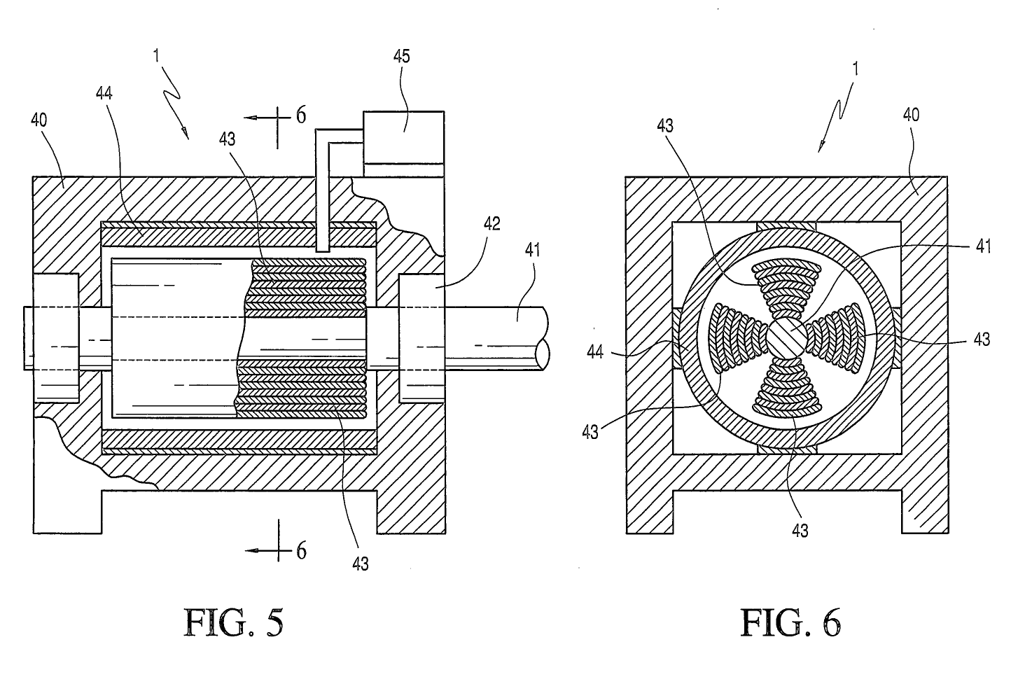

In accordance with a preferred embodiment of the present invention, and with reference to FIGS. 5 and 6, the present high torque electric motor 1 includes a lightweight high strength frame 40. In accordance with a preferred embodiment, the frame 40 is constructed from high strength steel or the like. The high torque electric motor 1 also includes a motor shaft 41 rotatably mounted upon the frame 40. As is discussed in greater detail below, the motor shaft 41 is 20% larger than comparable motor shafts and of similar improvements in strength.

In view of the added loads applied to the motor shaft 41, the bearings 42 supporting the shaft 41 relative to the frame 40 are selected to handle the increased load contemplated during operation of the present high torque electric motor 1.

The rotor windings 43 are secured about the motor shaft 41 and work in conjunction with the motor stator 44 of the motor 1 to drive the present motor 1. The arrangement of the rotor windings 43 allows the motor 1 to run at lower speeds while the strengthened construction of the shaft 41 and bearings 42 allows the motor 1 to handle higher temperatures and are also arranged to allow for lower operating motor speeds while used in conjunction with the rotors of the present motor 1.

As will be discussed below, the high operating levels of the present motor results in increased heat. The motor 1 is accordingly provided with an external air blower 45 to assist in cooling of the present motor 1.

More particularly, and in accordance with a preferred embodiment of the present invention, the high torque electric motor 1 is either a special design AC motor or a special design DC motor specifically designed to offer operation in accordance with the methodologies described herein. For example, the high torque AC or DC electric motor in accordance with the present invention is designed to operate during start-up for repeated but limited time periods while producing torque measuring at least four-times (400%) greater than the standard torque values of an equivalent size AC or DC electric motor. The maximum torque value the motor could produce would be slightly less than the lock rotor value. The operation of the motor is at high torque in excess of a standard equivalent motor. The motor is modified so that the shaft rpm is run at a slower speed than the standard motor to maximize torque; e.g., 450-600 rpm. The actual rpm depends upon the motor size. The motor frame is strengthened by using light weight fabricated steel.

The ability of the high torque electric motor 1 to create high torque values enables the impulse method of operation to be used successfully. The high torque values of the present high torque electric motor 1 are achieved by the use of additional cooling of the motor components for rapid and controlled removal of the heat created during each start-up. This cooling is achieved by use of forced air-cooling using a separate cooling system. In addition, the present high torque electric motor 1 is provided with strengthened armature windings, motor frame and motor bearings. The arrangement of the armature winding of the high torque electric motor 1 is also altered to handle and dissipate the heat generated by the repeated starts without overheating. In addition, the motor shaft size is increased by 20% to strengthen the shaft.

Some of the differences between a standard AC and DC electric motor to the present high torque electric motor include the fact the standard electric motor is limited to being restarted only a small number of times each hour or each day in order to prevent overheating and failure of its armature windings and other internal components. In addition, the maximum torque the standard electric motor can produce during start-up is lower and the time period over which it can produce torque is shorter. Also, the design of the standard electric motor is arranged for continuous operation while producing its normal rated torque and horsepower. The present high torque electric motor 1 is designed for short periods of operation during which it produces high values of torque that exceed the rating of a standard electric motor of comparable size.

The types of AC motors from which the high torque electric motor 1 can be made include (but are not limited to) the induction type, the synchronous type, and the polyphone type. The types of DC motors include (but are not limited to) the series-wound type, the shunt-wound type and the compound wound type. The output shaft of the high torque electric motor 1 connects to and powers the ADBS gearbox transmission 2. The high torque electric motor 1 can be replaced by a hydraulic motor as an alternative arrangement.

In accordance with a preferred embodiment of the present invention, it is contemplated the present high torque electric motor 1 may be powered in one or more of the following manners. For example, the present high torque electric motor 1 may be powered by AC electric power delivered from the power company by the AC power line 38. The present high torque electric motor 1 may also be powered by DC electric power supplied by the storage batteries 39. The storage batteries would be located either at the wind turbine 200 or in a remote location. If necessary, the DC power could be converted to AC power by auxiliary equipment. The storage batteries 39 can be arranged to be recharged by a portion of the electricity generated by the wind turbine 200 when it is in operation by use of suitable recharging equipment. This method increases the “green nature” of the auxiliary drive/brake system 100 by eliminating use of electric power delivered separately by the power company. The present high torque electric motor 1 may also be powered by DC electric power created by converting the AC electric power delivered by the AC power line 38.

The electric cables from the AC power line 38 or storage batteries 39 that supply the AC or DC electric power to the high torque electric motor 1 are arranged to rotate with the wind turbine nacelle 37 when it rotates (yaws) about the wind turbine tower 22 whenever the wind changes direction.

The high torque electric motor 1 connects directly to the ADBS gearbox/transmission 2 by use of suitable drive couplings 15. The ADBS gearbox/transmission 2 is a separate gearbox or transmission. It contains the gearing, the input shaft, and the output shaft. The input shaft receives the input torque and horsepower from the high torque electric motor 1. The output shaft connects to the ADBS driveshaft 3.

The ADBS gearbox/transmission 2 is preferably a gearbox that uses fixed ratio gearing. The gear ratio of the ADBS gearbox/transmission 2 is designed to operate within the same rpm range of the wind turbine rotor blades 7 and wind turbine input shaft 8. The ADBS gearbox/transmission 2 is equipped with its own lubrication system or is connected to the lubrication system used on the wind turbine gearbox 9. The gear arrangement can be double reduction, triple reduction or another type. It is contemplated the ADBS gearbox/transmission may also be one of the following gearbox types:
A gearbox that uses a fixed ratio roller chain and sprocket drive.
A variable speed transmission that uses a drive belt and adjustable pulley arrangement. The variable ratio design is arranged for variable speed using automatic and/or manual shifting.
A variable speed automatic transmission that uses changeable synchromesh gearing. The gearing is arranged to change using an automatic or manual shifting mechanism.

The ADBS driveshaft 3 connects the output shaft of the ADBS gearbox/transmission 2 to the ADBS transfer gearbox 4. The ADBS driveshaft 3 is fitted with suitable drive couplings 15 to enable it, the ADBS gearbox/transmission 2, and the ADBS transfer gearbox 4 to be installed and removed for maintenance.

The ADBS transfer gearbox 4 is a separate gearbox that contains the input shaft 5 of the ADBS transfer gearbox 5 and the output shaft of the ADBS transfer gearbox 6. The ADBS transfer gearbox 4 transfers the output rpm, torque and horsepower from the ADBS gearbox/transmission 2 to the wind turbine low-speed shaft 8. The ADBS driveshaft 3 connects to and drives the input shaft 5 of the ADBS transfer gearbox 4. The output shaft 6 of the ADBS transfer gearbox 4 connects to and drives the wind turbine low-speed shaft 8.

The gear ratio of the ADBS transfer gearbox 4 can be arranged for direct transfer of the output rpm, torque and horsepower from the ADBS gearbox/transmission 2 or to provide an additional rpm reduction and torque multiplication of it.

In accordance with a preferred embodiment, the ADBS transfer gearbox 4 is a gearbox that uses fixed ratio gearing. The gear arrangement can be double reduction, triple reduction or another type. In accordance with alternate embodiments, it is contemplated the ADBS transfer gear box 4 may be one of the following gearbox types:
A gearbox that uses a fixed ratio roller chain and sprocket drive.
A gearbox that uses a fixed or variable ratio drive belt and pulley arrangement. the variable ratio design is arranged for variable speed using automatic and/or manual shifting.
A variable speed automatic transmission that uses changeable synchromesh gearing. The gearing is arranged to change using an automatic or manual shifting mechanism.

The ADBS transfer gearbox 4 is located on the wind turbine low-speed shaft 8 between the wind turbine rotor blades 7 and the wind turbine gearbox 9.

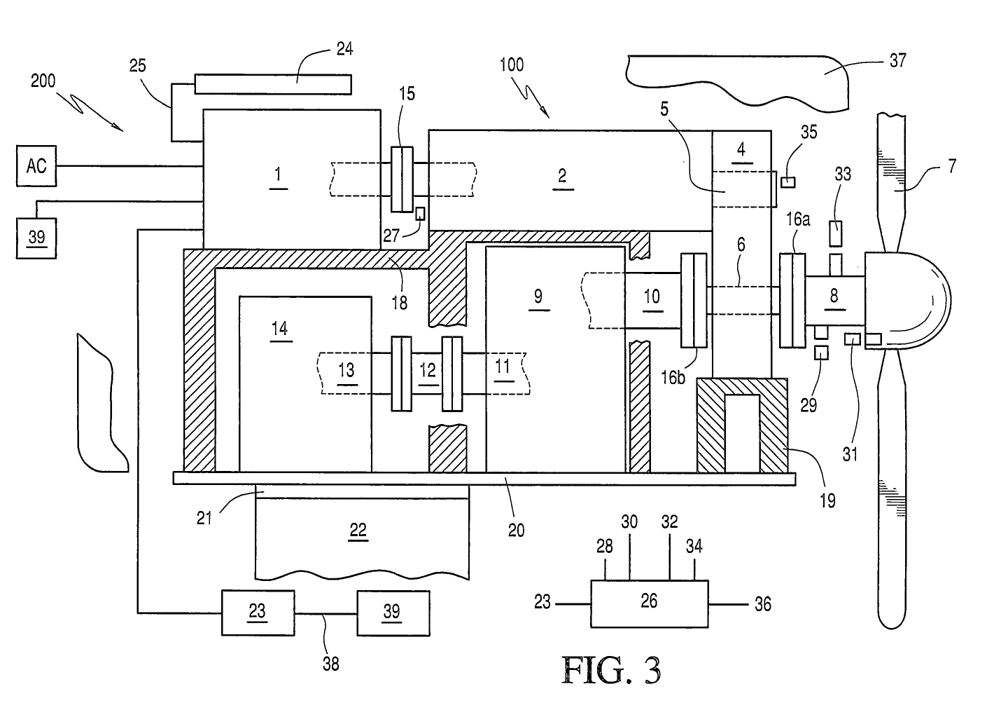

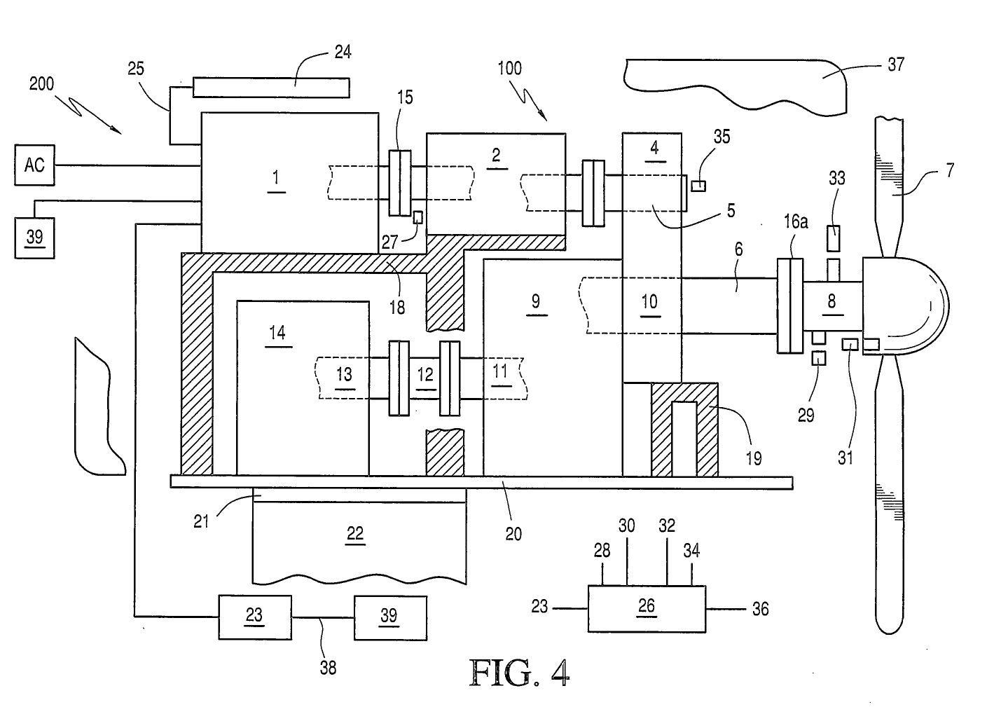

The arrangement and attachment of the ADBS transfer gearbox 4 onto the wind turbine low-speed shaft 8 is by one of the following methods:
One side of the output shaft 6 of the ADBS transfer gearbox 4 is attached to the wind turbine low-speed shaft 8 by the drive coupling 16a. The opposite side of the output shaft 6 of the ADBS transfer gearbox 4 is attached by the second drive coupling 16b directly to the input shaft 10 of the wind turbine gearbox 9. See FIGS. 2 and 3.
The ADBS transfer gearbox 4 is built directly into the ADBS gearbox/transmission 2. See FIG. 3. In accordance with this embodiment, the ADBS gear shaft 3 either is not used or is incorporated into the ADBS gear box.
The ADBS transfer gearbox 4 is built directly into the wind turbine gearbox 9. See FIG. 4. For this design the input shaft 10 of the wind turbine gearbox 9 is lengthened and forms the output shaft 6 of the ADBS transfer gearbox 4. In accordance with this embodiment, the ADBS driveshaft 3 either is not used or is incorporated into the ADBS gearbox/transmission 2. The first drive coupling 16a is used to attach the wind turbine low-speed shaft 8 to the combined input shaft 10 of the wind turbine gearbox 9/output shaft 6 of the ADBS transfer gearbox 4. The second drive coupling is not used.

The high torque electric motor 1 and the ADBS gearbox/transmission 2 are supported by and fastened to the support frame ADBS motor & gearbox 18 which is fastened to the base plate 20. The support frame ADBS motor & gearbox 18 is installed in and enclosed within the wind turbine nacelle 37.

The ADBS transfer gearbox 4 is fastened to the base plate 20 or to the support frame 19 of the ADBS transfer gearbox 4 as required. When the support frame 19 of the ADBS transfer gearbox 4 is used, it is fastened to the base plate 20.

The preferred location of the high torque electric motor 1 and the ADBS gearbox/transmission 2 within the wind turbine nacelle 37 is above the wind turbine generator 14 and wind turbine gearbox 9 and close to the vertical centerline of the wind turbine tower 22. This location allows the wind turbine tower 22 to support the weights and loads along its vertical axis and reduces cantilever bending of the entire wind turbine 200. An alternate arrangement is for one or more of the ADBS components to be located in the vertical plane and above or below the wind turbine nacelle 37.

The motor drive control system 23 controls the high torque electric motor 1. The motor drive control system 23 is preferably a computer controlled drive system using electronic and/or mechanically actuated controls. However, it is contemplated the motor drive control system may also be an electronic variable speed drive.

The motor drive control system 23 performs the following functions:
It controls the operation speed (rpm), and direction of rotation of the output shaft of the high torque electric motor 1;
It enables the speed (rpm) of the output shaft of the high torque electric motor 1 to be adjusted to suit the operating conditions of the wind turbine 200 in order to generate the maximum amount of electricity for the longest period of time;
It enables the high torque electric motor 1 to be started and stopped with reduced shock load to the drive components of the wind turbine 200 and the auxiliary drive/brake system 100; and
It enables the high torque electric motor 1 to be used as a generator for dynamic braking of the wind turbine 200.

The resistor grid 24 is a series of resistors located on the exterior of the wind turbine nacelle 37. The resistor grid 24 is used to dissipate the electricity produced by the high torque electric motor 1 when it is operated as a generator for dynamic braking by the motor drive control system 23. The electricity created by the high torque electric motor 1 when it operates as a generator is directed to the resistor grid 24 by the resistor grid power cable 25. The resistor grid 24 then converts the electricity to heat and dissipates it into the air at the exterior of the wind turbine nacelle 37.

The electronic speed control 26 is the primary control system for the auxiliary drive/brake system 100. The purpose of the electronic speed control 26 is to:
Activate and control the motor drive control system 23.
Reduce the shock load to the wind turbine 200 and the auxiliary drive/brake system 100 whenever the auxiliary drive/brake system 100 is activated or removed from service by matching the speed (rpm) of the wind turbine low-speed shaft 8 to the shaft speed (rpm) of the auxiliary drive/brake system 100.
Enable the auxiliary drive/brake system 100 to be deactivated at any time in order to allow the wind turbine 200 to operate by wind only.
Activate the dynamic braking function.

The electronic speed control 26 uses electronic or mechanical tachometer-type sensors positioned on the wind turbine low-speed shaft 8 and the ADBS driveshaft 3 or the input shaft 5 of the ADBS transfer gearbox 4. The tachometer-type sensor 29 is located on the wind turbine low-speed shaft 8, the tachometer-type sensor 27 is located on the ADBS driveshaft 3 or the ADBS input shaft 5.

The tachometer-type sensors can be combined or replaced with force-type sensors as an alternate arrangement.

An optional arrangement is to place the tachometer-type sensor that is located on the ADBS driveshaft 3 onto the ADBS gearbox/transmission 2, or onto one of the other rotating components of the auxiliary drive/brake system 100. In addition, the following controls are linked to the electronic speed control 26:
Yaw control mechanism—rotor blades 31. The control signal from it is transmitted by the signal cable—yaw control mechanism 32 to the electronic speed control 26.
Input shaft brake mechanism 33 provided the wind turbine 200 is equipped with it. The control signal from it is transmitted by the signal cable—input shaft brake 34 to the electronic speed control 26.
Gear ratio of the ADBS gearbox/transmission 2 provided the variable speed type of gearbox/transmission is used, the gear ratio is recorded by transmission sensor 35 and is transmitted by the signal cable—transmission 36 to the electronic speed control 26.
The control signals and rpm of the motor drive control system 23.

The electronic speed control 26 controls the speed of the auxiliary drive/brake system 100 by use of one or more of the following methods:
By adjusting the rpm of the high torque electric motor 1 using the motor drive control 23.
By adjusting the gear ratio of the ADBS gearbox/transmission 2 if the variable speed type of gearbox/transmission is used.

The electronic speed control 26 controls the speed of the wind turbine low-speed shaft 8 by use of one or more of the following methods: a) by adjusting the yaw control mechanism—rotor blades 31, it functions by positioning the wind turbine rotor blades 7 to further engage or disengage the wind; b) by activating the input shaft brake mechanism 33 provided the wind turbine 200 is equipped with it. The input shaft brake mechanism 33 functions by slowing the wind turbine low-speed shaft 8; c) by activating the dynamic braking function of the auxiliary drive/brake system 100.

The control signals, settings, and rpm of the electronic speed control 26, the motor drive control system 23, the wind turbine low-speed shaft 8, the ADBS driveshaft 3, and the megawatt output of the wind turbine generator 14 are displayed and recorded in the power company control room for observation and analysis. In addition, this information is arranged for display at the wind turbine 200 site for local control and on-site evaluation of the wind turbine 200 and the auxiliary drive/brake system 100 whenever this is necessary

With the foregoing discussion in mind, the present invention offers a wide variety of advantages. These include, but are not limited to, the use of the high torque electric motor 1, the ADBS gearbox/transmission 2, the ADBS transfer gearbox 4 and the motor drive control system 23 to power the wind turbine 200; the arrangement and use of the high torque electric motor 1 and the resistor grid 24 to serve as a dynamic brake for the wind turbine rotor blades 7; and the use of the motor drive control system 23 and the electronic speed control 26 to enable the auxiliary drive/brake system 100 to automatically engage and disengage the operating wind turbine 200 at the same shaft speed in order to reduce the shock to the components and provide a smooth transition; the use of the auxiliary drive/brake system 100 to increase the minimum and maximum range of wind speed over which the wind turbine 200 can operate to produce electricity.

The “impulse” method of operation as discussed above of the high torque electric motor 1 by which the high torque electric motor 1 is operated in a start-stop manner repeatedly to impart “impulse acceleration” (short duration power impulses) into the wind turbine low-speed shaft 8 and wind turbine rotor blades 7 enables the wind turbine rotor blades 7 to keep turning for a longer period of time and enables the wind turbine generator 14 to continue to produce electricity. The “impulse” method of operation is based on the ability of the high torque electric motor 1 to produce torque and horsepower that exceed its rated value by 4-5 times (400%-500%) for a limited period of time whenever it is started. The present invention also uses the storage batteries 39 and the AC power line 38 to power the high torque electric motor 1.

The present invention also provides advantages over existing technology and markets because the auxiliary drive/brake system 100 provides the following advantages to the wind turbine 200: a) it enables the wind turbine 200 to remain in operation and generate electricity when the wind speed is below the minimum wind speed required for normal wind-only operation increasing the operating range and daily operating period of the wind turbine 200; b) it enables the wind turbine 200 to remain in operation and generate electricity when the wind speed is too intermittent to enable normal wind-only operation increasing the operating range and daily operating period of the wind turbine 200; c) it enables the wind turbine to remain in operation for a limited period of time and generate electricity when the wind stops in order to provide the power company sufficient time to bring a replacement electricity generation resource into operation thereby improving the reliability and flexibility of the wind turbine 200 greatly; d) it enables the wind turbine 200 to remain in operation when the wind speed exceeds the maximum allowable wind speed by having the high torque electric motor 1 provide dynamic braking of the wind turbine rotor blades 7.

The present auxiliary drive/brake system 100 provides the power company with the ability to operate its wind turbine 200 for a longer period of time each day (the longer operating period increases the revenue and the return on investment (ROI) the power company can earn from the wind turbine 200), to improve the stability and reliability of the power company electric transmission system by reducing the rapid drop or swing in electricity generation that wind turbines 200 create whenever the wind either stops completely or slows rapidly (this reduces the potential for a “blackout” and “brownout” upset or failure of the power company electric transmission system that result when a rapid power drop or swing occurs), to improve the stability and reliability of the power company electric transmission system whenever the wind either stops completely by providing additional time for the power company to bring another electricity generation source into operation (this reduces the potential for a “blackout” and “brownout” upset or failure of the power company electric transmission system that result when a rapid power drop occurs), and to reduce its use of fossil fuels for electricity generation.

By reducing the use of fossil fuels the power company is able to reduce the yearly cost for fossil fuel the power company requires for operation, increase the amount of emission credits the power company can obtain and either use itself or sell trade to other power companies for profit, sell the fossil fuel it has in its inventory but does not need for electricity generation to other power companies or other industries, and reduce the need for the power company to operate its own fossil fuel power plants (this reduces the maintenance costs for the fossil fuel power generation plants owned by the power company).

The present invention also is designed such that the auxiliary drive/brake system 100 can be installed on all types of wind turbines, although the primary application is for large wind turbines of the 0.50 megawatt range and larger.

While the preferred embodiments have been shown and described, it will be understood that there is no intent to limit the invention by such disclosure, but rather, is intended to cover all modifications and alternate constructions falling within the spirit and scope of the invention.

1. An auxiliary drive/brake system for a wind turbine, the wind turbine including wind turbine rotor blades connected to a wind turbine low-speed shaft, the wind turbine low-speed shaft drives a wind turbine gearbox via an input shaft of the wind turbine gearbox, an output shaft of the wind turbine gearbox and a wind turbine high speed shaft which connects to an input shaft of the wind turbine generator that produces electricity that is supplied to a power company electricity transmission network, the auxiliary drive/brake system comprising:
an impulse, high torque electric motor connected to a motor drive control system which controls the high torque electric motor;
a gearbox transmission;
a drive shaft; and
a transfer gearbox that connects to either the wind turbine low-speed shaft or to the wind turbine gearbox;
wherein control of the auxiliary drive/brake system is performed by an electronic speed control in combination with either a motor drive control system or an electronic variable speed drive;
and torque and horsepower created by the present auxiliary drive/brake system is transferred into the wind turbine low-speed shaft where it combines with the torque and horsepower created by the wind acting on the wind turbine rotor blades, the combined torque and horsepower is transferred from the wind turbine low-speed shaft into the wind turbine gearbox and the wind turbine generator, causing the wind turbine generator to operate and produce electricity which is supplied to the power company.

2. The auxiliary drive/brake system according to claim 1, wherein the high torque electric motor includes a lightweight high strength frame supporting a large motor shaft and an external air blower.

3. The auxiliary drive/brake system according to claim 1, wherein the high torque electric motor is powered by AC electric power delivered from an AC power line, DC electric power converted from AC, or DC electric power supplied by a storage battery.

4. The auxiliary drive/brake system according to claim 1, wherein gearbox transmission is a gearbox using fixed ratio gearing.

5. The auxiliary drive/brake system according to claim 1, wherein the transfer gearbox is connected to the wind turbine low-speed shaft by a first drive coupling and an opposite side of the transfer gearbox is attached to the input shaft of the wind turbine gearbox by the second drive coupling.

6. The auxiliary drive/brake system according to claim 1, wherein the transfer gearbox is built directly into the gearbox transmission.

7. The auxiliary drive/brake system according to claim 1, wherein the transfer gearbox is built directly into the wind turbine gearbox.

8. The auxiliary drive/brake system according to claim 1, wherein the motor drive control system controls the high torque electric motor.

9. The auxiliary drive/brake system according to claim 8, wherein the motor drive control system includes means for controlling the operation, speed and direction of rotation of the high torque electric motor, adjusting the speed of the high torque electric motor to suit the operating conditions of the wind turbine, enabling the high torque electric motor to be started and stopped with reduced shock load, and enabling the high torque electric motor to be used as a generator for dynamic braking of the wind turbine.

10. A wind turbine including an auxiliary drive/brake system, comprising:
a wind turbine comprising wind turbine rotor blades connected to a wind turbine low-speed shaft, the wind turbine low-speed shaft drives a wind turbine gearbox via an input shaft of the wind turbine gearbox, an output shaft of the wind turbine gearbox and a wind turbine high speed shaft which connects to an input shaft of the wind turbine generator that produces electricity that is supplied to a power company electricity transmission network; and
an auxiliary drive/brake system comprising: an impulse, high torque electric motor connected to a motor drive control system which controls the high torque electric motor; a gearbox transmission; a drive shaft; and a transfer gearbox that connects to either the wind turbine low-speed shaft or to the wind turbine gearbox; wherein control of the auxiliary drive/brake system is performed by an electronic speed control in combination with either a motor drive control system or an electronic variable speed drive; and
wherein torque and horsepower created by the present auxiliary drive/brake system is transferred into the wind turbine low-speed shaft where it combines with the torque and horsepower created by the wind acting on the wind turbine rotor blades, the combined torque and horsepower is transferred from the wind turbine low-speed shaft into the wind turbine gearbox and the wind turbine generator, causing the wind turbine generator to operate and produce electricity which is supplied to the power company.

11. The wind turbine according to claim 10, wherein the high torque electric motor includes a lightweight high strength frame supporting a large motor shaft and an external air blower.

12. The wind turbine according to claim 10, wherein the high torque electric motor is powered by AC electric power delivered from an AC power line, DC electric power converted from AC or DC electric power supplied by a storage battery.

13. The wind turbine according to claim 10, wherein the gearbox transmission is a gearbox using fixed ratio gearing.

14. The wind turbine according to claim 10, wherein the transfer gearbox is connected to the wind turbine low-speed shaft by a first drive coupling and an opposite side of the transfer gearbox is attached to the input shaft of the wind turbine gearbox by the second drive coupling.

15. The wind turbine according to claim 10, wherein the transfer gearbox is built directly into the gearbox transmission.

16. The wind turbine according to claim 10, wherein transfer gearbox is built directly into the wind turbine gearbox.

17. The wind turbine according to claim 10, wherein the motor drive control system controls the high torque electric motor.

18. The wind turbine according to claim 17, wherein the motor drive control system includes means for controlling the operation, speed and direction of rotation of the high torque electric motor, adjusting the speed the high torque electric motor to suit the operating conditions of the wind turbine, enabling the high torque electric motor to be started and stopped with reduced shock load, and enabling the high torque electric motor to be used as a generator for dynamic braking of the wind turbine.
